(19) United States
(12) Patent Application Publication
(10) Pub. No.: US 2018/0060235 A1
(43) Pub. Date: Mar. 1, 2018

(54) NON-VOLATILE MEMORY COMPRESSION DEVICES AND ASSOCIATED METHODS AND SYSTEMS

(71) Applicant: Intel Corporation, Santa Clara, CA (US)

(72) Inventors: Kirk S. Yap, Westborough, MA (US); Vinodh Gopal, Westborough, MA (US); James D. Guilford, Northborough, MA (US)

(73) Assignee: Intel Corporation, Santa Clara, CA (US)

(21) Appl. No.: 15/252,084

(22) Filed: Aug. 30, 2016

(51) Int. Cl. G06F 12/0815; G06F 3/06

(52) U.S. Cl. CPC G06F 12/0815; G06F 3/0614; G06F 2212/621; G06F 3/0673; G06F 3/0638

(57) ABSTRACT

Memory compression devices, systems, and associated methods are provided and described. Such devices, systems, and methods increase the effective bandwidth and reduce power consumption of non-volatile memory subsystems.

### BACKGROUND

Computational devices and systems have become integral to many peoples' lives, from the personal mobile space to large networking systems. Such devices and systems not only provide enjoyment and convenience, but also can greatly increase productivity, creativity, social awareness, and the like. One consideration that can affect such beneficial effects relates to the speed and usability of the devices themselves. Impatience brought on by slow system speeds, short battery life, and the like, can limit or even eliminate these beneficial effects for many.

Memory subsystems play an important role in the implementation of such devices and systems, and are one of the factors affecting system performance. Such memory subsystems can greatly affect the speed and power consumption of associated memory.

### BRIEF DESCRIPTION OF THE DRAWINGS

FIG. 1 is a schematic view of an exemplary compression controller;

FIG. 2A is a graphical representation of an example of two halves of a memory line;

FIG. 2B is a graphical representation of an example of two halves of a memory line;

FIG. 2C is a graphical representation of an example of two halves of a memory line;

FIG. 3 is a representation of exemplary method steps;

FIG. 4 is a representation of exemplary method steps;

FIG. 5 is a representation of exemplary method steps;

FIG. 6 is a representation of exemplary method steps; and

FIG. 7 is a schematic view of an exemplary computing system.

### DESCRIPTION OF EMBODIMENTS

Although the following detailed description contains many specifics for the purpose of illustration, a person of ordinary skill in the art will appreciate that many variations and alterations to the following details can be made and are considered included herein.

Accordingly, the following embodiments are set forth without any loss of generality to, and without imposing limitations upon, any claims set forth. It is also to be understood that the terminology used herein is for describing particular embodiments only, and is not intended to be limiting. Unless defined otherwise, all technical and scientific terms used herein have the same meaning as commonly understood by one of ordinary skill in the art to which this disclosure belongs.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term in this written description, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

As used herein, “enhanced,” “improved,” “performance-enhanced,” “upgraded,” and the like, when used in connection with the description of a device or process, refers to a characteristic of the device or process that provides measurably better form or function as compared to previously known devices or processes. This applies both to the form and function of individual components in a device or process, as well as to such devices or processes as a whole.

As used herein, “coupled” refers to a relationship of physical or electrical connection or attachment between one item and another item, and includes relationships of either direct or indirect connection or attachment. Any number of items can be coupled, such as materials, components, structures, layers, devices, objects, etc.

As used herein, “directly coupled” refers to a relationship of physical or electrical connection or attachment between one item and another item where the items have at least one point of direct physical contact or otherwise touch one another. For example, when one layer of material is deposited on or against another layer of material, the layers can be said to be directly coupled.

Objects or structures described herein as being “adjacent to” each other may be in physical contact with each other, in close proximity to each other, or in the same general region or area as each other, as appropriate for the context in which the phrase is used.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

### Example Embodiments

An initial overview of embodiments is provided below and specific embodiments are then described in further detail. This initial summary is intended to aid readers in understanding the disclosure more quickly, but is not intended to identify key or essential technological features, nor is it intended to limit the scope of the claimed subject matter.

Presently disclosed are devices, systems, and methods relating to memory compression at the access granularity of a given memory device. Such memory compression-based management can enhance the performance of a memory subsystem, which in turn can lead to enhanced performance of an associated system. Enhancements can include, without limitation, higher capacity, higher effective bandwidth, power savings, read latency reduction, and the like. For example, the present memory compression techniques can increase the effective bandwidth of a memory interface and reduce power consumption, which is currently a limiting factor in memory interface bandwidth.

Any type of memory and/or memory interface capable of utilizing memory compression is considered to be within the present scope. In one example, however, reference to memory devices, subsystems, interfaces, and the like, can refer to nonvolatile memory (NVM), which maintains its memory state even if power is interrupted to the device. In one embodiment, the NVM device can be a block addressable memory device, such as a NAND or NOR device. A memory device can include current generation and future generation nonvolatile devices, including without limitation, byte addressable write-in-place non-volatile memory (e.g. three dimensional cross point memory), as well as other byte addressable nonvolatile memory devices. In one embodiment, and without limitation, a memory device can be or include multi-threshold level NAND flash memory, NOR flash memory, single or multi-level Phase Change Memory (PCM), resistive memory, nanowire memory, ferroelectric transistor random access memory (FeTRAM), magnetoresistive random access memory (MRAM), memory that incorporates memristor technology, spin transfer torque (STT)-MRAM, or the like, including any combination thereof.

Memory compression can be utilized to enhance performance of a NVM interface by, at least in part, reducing bandwidth associated with transactions to the NVM. While this is true for nearly all, if not all, NVM technologies, it can be particularly beneficial for types of NVM that support write-in-place, small granularity access. One example of such a NVM is PCM arranged in an array, such as a cross point array of word and bit lines.

As described above, memory compression in the present context refers to data compression in memory at the granularity of a memory line (i.e. access granularity of the memory), and which is managed by hardware, such as, for example, a dual in-line memory module (DIMM) based controller. This class of hardware-based memory compression schemes is different from other techniques, such as software/OS managed memory compression that can operate on other memory levels such as pages.

A hardware processor can execute instructions to operate on data, for example, to perform arithmetic, logic, or other functions, as well as to access data in memory, which can be in conjunction with a memory controller. In some cases, the processor can be a client requesting data access from a memory acting as a server for the data. In other cases, a computing device can include a hardware processor/memory controller that requests access to data, and the memory can be local to the computing device.

Memory can be divided into sections of data according to the specific hardware configurations of the processor or processors, memory devices, memory interfaces, memory controllers, and the like. Additionally, a given device or system can utilize memory sections of different sizes, depending on the subsystem. In other words, different components or subsystems can utilize different memory section sizes that are dependent on the respective access granularities. For example, the processor may operate at a system granularity of 64 bytes, while the memory access granularity may be 128 bytes, 256 bytes, etc. A memory line is defined as the size of an uncompressed data request on the memory side of the controller. Thus, in one non-limiting example, if the memory line is 256 bytes, and the memory access granularity is 128 bytes, then non-limiting memory segment sizes may be 32 bytes, 64 bytes, 128 bytes, 256 bytes, etc. Additionally, with a memory line of 256 bytes and a memory access granularity of 128 bytes, two data commands would be needed to retrieve or write an uncompressed memory line, one data command for each 128-byte segment of the memory line. By compressing the data of the memory line from 256 bytes to 128 bytes, and knowing which half of the memory line the data is stored in, only a single read command would be needed to retrieve the entire memory line.

Any useful memory section size, access granularity, and the like, are considered to be within the present scope. In some cases, a memory section size can be equal to the access granularity for a subsystem, while in other cases, a memory section size can be different from the access granularity. Non-limiting examples of memory section sizes can include 8 bits (or a byte) of data, 16 bits (a word), 32 bits (a doubleword), 64 bits (a quadword), 128 bits, 256 bits, 512 bits, or the like. In another non-limiting example, memory section sizes can include 8 bytes of data, 16 bytes, 32 bytes), 64 bytes, 128 bytes, 256 bytes, 512 bytes, or the like.

Accordingly, by compressing data to a compression level that allows a reduction in the number of data commands needed to perform a data operation, performance of the memory subsystem can be enhanced. As described in the example above, a two-command data request can be reduced to a one-command data request by compressing the data to, in this case, at least the size of the memory access granularity. The compression level, therefore, can be any compression level that results in a reduction of the number of data commands needed to perform a memory function, compared to performing the memory function on uncompressed data. In one example, data can be compressed to a size that is a multiple of the access granularity.

One technique that is useful for tracking the compression status of a memory segment or memory line involves the use of compression flags. Compression flags refer to bits that represent the compression state of each memory line, such as, for example, whether or not the memory line, or a memory segment of the memory line, has been compressed or not. In some cases, other optional information can include the extent of compression (e.g. occupies half the line, quarter the line, . . . ), location of the compressed payload within the line for write-count reduction, opportunistic improvement in system, reliability via higher error correction code (ECC), etc. The number of compression flag bits needed per line depends on what compression features are supported by a given system, and whether or not those features are implemented. Additionally, the capacity of memory in systems continuously increases, and given the size of many memory devices, each compression bit per memory line could translate into a significant amount of storage for the compression flags. For example, for a cross point memory architecture DIMM, DIMM capacity could range from 512 GB to 6 TB. For a memory line size of 128 bytes in this example, each bit used in the compression flag would need 512 GB to 6 TB of memory storage.

Furthermore, in order to avoid a major impact on memory transaction latencies, the compression flags ideally would be readily available and stored locally at the controller. Storing all of the compression flags locally at the compression controller, however, can be prohibitive given the large memory storage needs for the compression flag bits. Additionally, other issues can include how the compression flag storage would be initialized, as initialization is needed, particularly for the usage of non-volatile data. Initialization in this context refers to the process of populating the flag storage structure (in the compression controller, for example) with the compressed state information for each memory line, before the start of normal operation. Another issue relates to how power fail requirements in a computing system are satisfied. During system power failure events the states associated with the memory need to be saved in the memory in a “reasonable” amount of time. Saving 4 GB of data (or more with additional bits per flag) into memory during power fail events can be a prohibitively costly and difficult task.

In one example embodiment, a solution to these issues is provided by storing the compression flags for each memory line in the metadata associated with that memory line. This solution allows the compression flag values to be updated at the time of a write operation, which allows the compression flags in the memory to be valid at all times. This design also solves the problems associated with saving the compression flags during power fail events. Simply flushing all outstanding writes, which is already performed during power fail events, will accomplish the requirement to save all states including the compression flag states because the compression flags have already been saved. Additionally, when a memory line is read during a read transaction, the correct state of the compression flags will always be available without needing to perform additional memory accesses.

In those cases, where longer boot times are undesirable, designs can be implemented that reduce or eliminate the need to initialize the compression flags for all memory lines. In one example, the compression flags can initially all be marked invalid at the time of system boot, thus eliminating the need to read the entire memory to determine the compressed state of each memory line. The compressed state can be readily determined from the stored metadata by reading the entire memory line upon an initial read or write request for the memory line following system boot.

As describe above, it can be beneficial to utilize memory compression to enhance performance, in some cases by compressing data to reduce bandwidth usage across a data pathway, and to decompress the data to fulfill a data request. In one example, a memory controller (i.e. compression controller) can function to compress and/or decompress data to achieve such performance improvements to a system. Such a memory controller can utilize these memory compression techniques for data transfer over an interconnect, bus, or other coupling. Certain embodiment designs of compression and/or decompression can provide a higher effective bandwidth, increased power savings, read latency reductions, or the like, including any combination thereof.

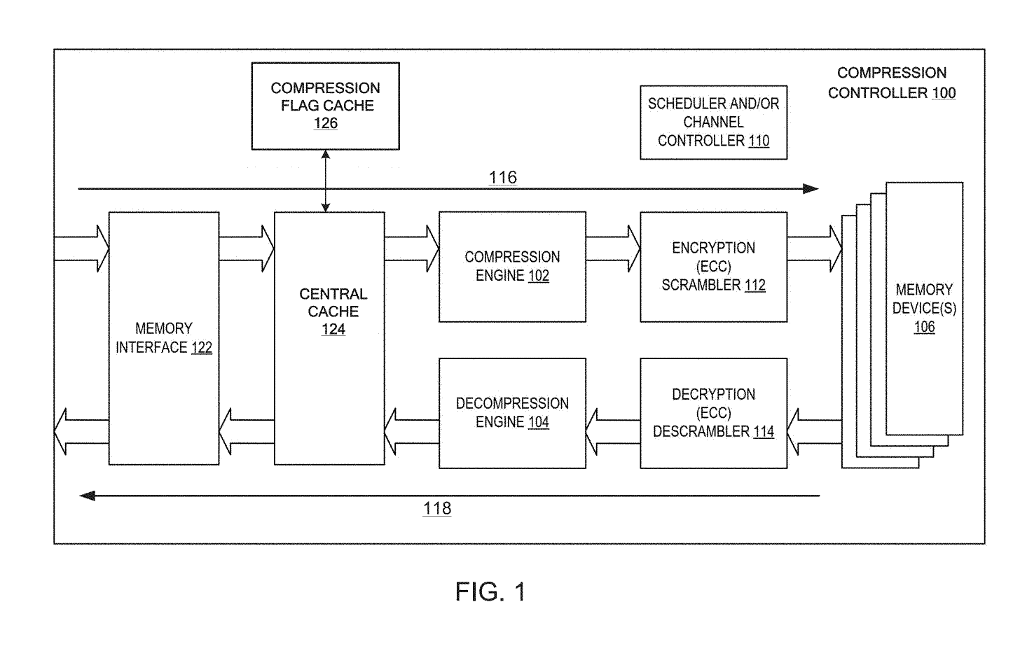

FIG. 1 shows one non-limiting embodiment of a hardware controller 100. To avoid confusion with other controllers in a computing system, such as the system memory controller, for example, the presently described controller will be referred to as a compression controller. It is noted, however, that the compression controller can perform other functions, and that the term “compression” should not be seen as limiting. The depicted compression controller 100 includes a compression engine 102, such as a compression circuit, and a decompression engine 104, such as a decompression circuit. Depending on the specific design, a compression controller or other compression circuitry can include one or both of a compression engine and a decompression engine. The compression engine 102 receives uncompressed data and outputs the compressed data. For example, a compression engine may output the compressed data to one or more memory devices 106 for storage. The decompression engine 104 receives compressed data and outputs decompressed data. For example, the decompression engine 104 may receive the compressed data stored in one or more memory devices 106. The design and implementation of compression and decompression controllers can vary depending on the particular compression and decompression algorithms used. Any algorithm capable of compressing or decompressing memory to the extent described herein is considered to be within the present scope. A few non-limiting examples include Frequent Pattern Compression (FPC) algorithms, Direct Mapped compression algorithms (e.g., WKdm, WKS), Lempel-Ziv algorithms (e.g. LZO), 842 algorithms (from IBM®), and the like.

The memory device or devices 106 can include any type, design, or configuration of memory device, non-limiting examples of which are outlined above. Memory devices 106, in some examples, can reside in a server or other device or system that is remote from the compression controller 100. In other examples, the memory devices 106 can reside locally with the compression controller 100.

In some examples, the compression controller 100 can include a scheduler and/or channel controller 110, which can function to schedule access to the one or more memory devices 106. The memory devices 106 include a plurality of channels that allow access along a write data path 116. The channel controller 110 can control which requests are allowed to access the memory devices 106 along which channels, thus avoiding potential interference between simultaneous data requests on the same channel.

The compression controller 100 can include an encryption scrambler 112 on the write data path 116 between the compression engine 102 and the memory devices 106. The encryption scrambler 112 can include circuitry to encrypt the data output from compression engine 102 in order to encrypt data and generate error correction codes (ECC) prior to storage.

The compression controller 100 can include a decryption descrambler 114 on the read data path 118 between the decompression engine 104 and the memory devices 106. The decryption descrambler 114 can include circuitry to decrypt data from the memory devices 106, in some cases prior to decompression if the data has been compressed. Decryption descrambler 114 can check the ECC included in the metadata for the memory line to determine if the data received with the ECC matches the data originally transmitted (stored) with that ECC.

The compression controller 100 can also include a central cache 124 coupled to a compression flag cache 126. The compression flag cache 126 is a memory buffer for storing compression flags or compression flag information. Due to the vast numbers of memory lines in the memory devices 106, it can be prohibitive to store compression flags for all memory lines in the compression flag cache, however such a design is contemplated and is within the present scope. In some examples, compression flags for only a subset of the memory lines of the memory devices 106 are stored in the compression flag cache 126. Compression flag cache 126 can be implemented as any type of memory device, buffer, or the like. As such, lookups of the compression flag cache 126 are performed for compression flags of a memory line associated with a data request to determine the compression status of data in the memory line. The compression flag cache can be local to the compression controller, and in some cases can be on-chip with the compression controller.

Compression controller 100 can also include a memory interface 122 to communicate with a data client, such as a processor or a processor core, for example. The design and configuration of memory interface 122 can vary depending on the design of the computing system, the design of memory, the design of the compression controller 100, and the like. As such, any memory interface design capable of interfacing and communicating with the present compression technology is considered to be within the present scope. Furthermore, the compression controller 100 can be utilized with a variety of devices, systems, methods, and the like, and can be integrated into a given device or system at any useful location associated with memory compression, compression flag caching, or the like. In one example embodiment, the compression controller can be a DIMM-based controller resident on each DIMM module having compression capabilities. In another example embodiment, the compression controller can be a DIMM-based controller located proximate to DIMM slots configured to hold DIMM modules. In another example embodiment, the compression controller can be associated with, or a subcomponent of, a controller hub, Southbridge, system memory controller, integrated controller, or the like.

As a general note, compression controllers, memory controllers, ECC usage, encryption scramblers, decryption descramblers, compression engines, decompression engines, memory caching, and the like, are all well known in the art, and one of ordinary skill in the art would readily understand the usage and potential designs of such elements once in possession of the present disclosure.

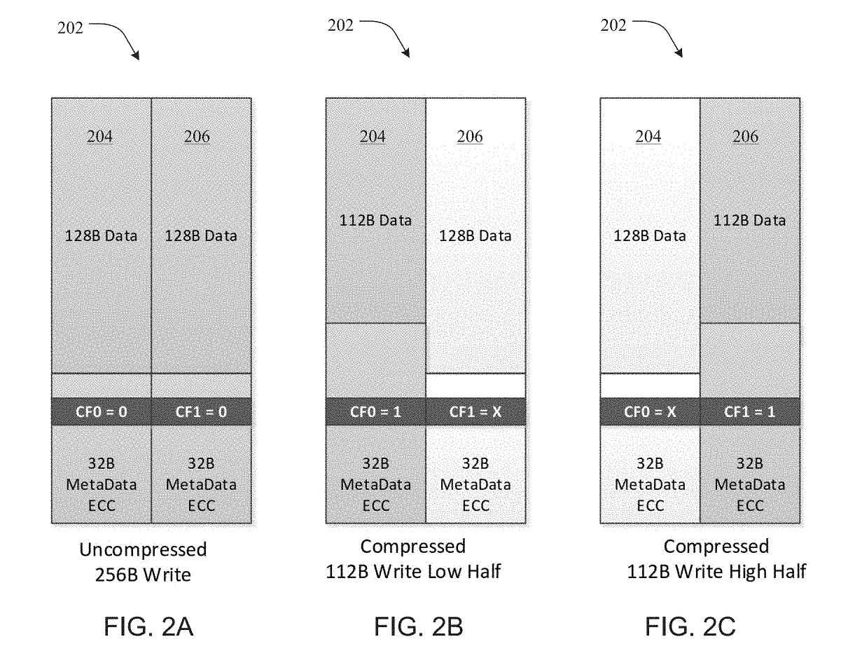

In one example, the compression flag bits for a memory line can reside completely within the data associated with the memory line, and additionally, the compression flag bits for a compressed memory line can reside completely within the memory segment in which the compressed data is written. FIGS. 2A-C show examples of compression flags for different scenarios. In this case, two compression flag (CF) bits, CF0 and CF1 respectively represent the “compression status” and “compressed line position” information for a given memory line 202. It is noted that the two segments (204, 206) of the memory line 202 are shown side-by-side in each of FIGS. 2A-C to show alignment of the compression flags. CF0 and CF1 are positioned in each segment (or half of a memory line in this example) of the memory line 202 at the same relative position within a 160 byte codeword. In other words, memory segments 204 and 206 each include a data portion of 128 bytes of data, and a metadata portion of 32 bytes of metadata, which totals 160 bytes. It is noted that a memory line with 256 bytes of uncompressed data can have a size that is greater than 256 bytes due to the inclusion of the metadata portions. When an uncompressed write is performed, the compression flags are both cleared to CF0=CF1=0, as in FIG. 2A. When a compressed write is performed, the CFn bit is set that corresponds to the memory segment of the memory line to which the compressed data is written, and the CFn bit in the non-written memory segment is left untouched as a result of only writing to half of the memory line. FIG. 2B shows an example of compressed data being written to the low segment 204 of the memory line 202, and FIG. 2C shows an example of compressed data being written to the high segment 206 of the memory line 202. It is noted that, while the memory lines 202 are shown with two memory segments, a memory line can be divided into any number of memory segments provided the size of these segments allows operability with the various access granularities of the system. Additionally, compression flags can be set to invalid (CF=X) upon powering up the system in order to, among other things, avoid the need to initialize the compression flags at system start.

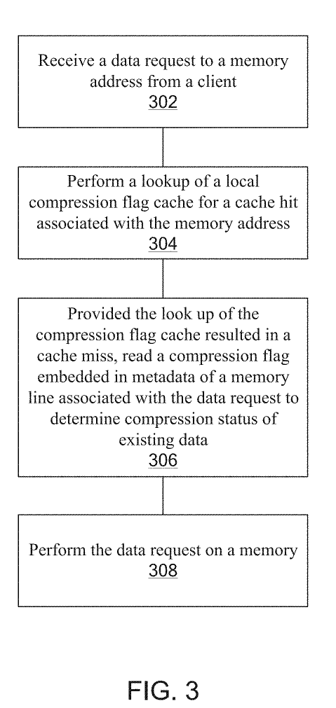

In one example, a process is shown in FIG. 3. For example, compression controller circuitry (such as, for example, at least a portion of the circuitry of FIG. 1) can be configured to perform the process of FIG. 3. The process can include: 302 receiving a data request to a memory address from a client via memory interface 122, 304 performing a lookup of a local compression flag cache 126 for a cache hit associated with the memory address. If the compression cache lookup resulted in a miss, the compression circuitry can 306 read a compression flag embedded in metadata of a memory line associated with the data request to determine compression status of existing data, and 308 perform the data request on a memory 106. In some examples, the compression controller device 100 can perform an address lookup in an address lookup table in order to determine the memory address for the data request. In some cases, the compression circuitry can read the compression flag embedded in metadata of the memory line associated with the data request if the compression cache lookup resulted in a hit. Reading the metadata of the memory line in such cases is not generally necessary, however, because the compression status is known from the cache hit of the lookup.

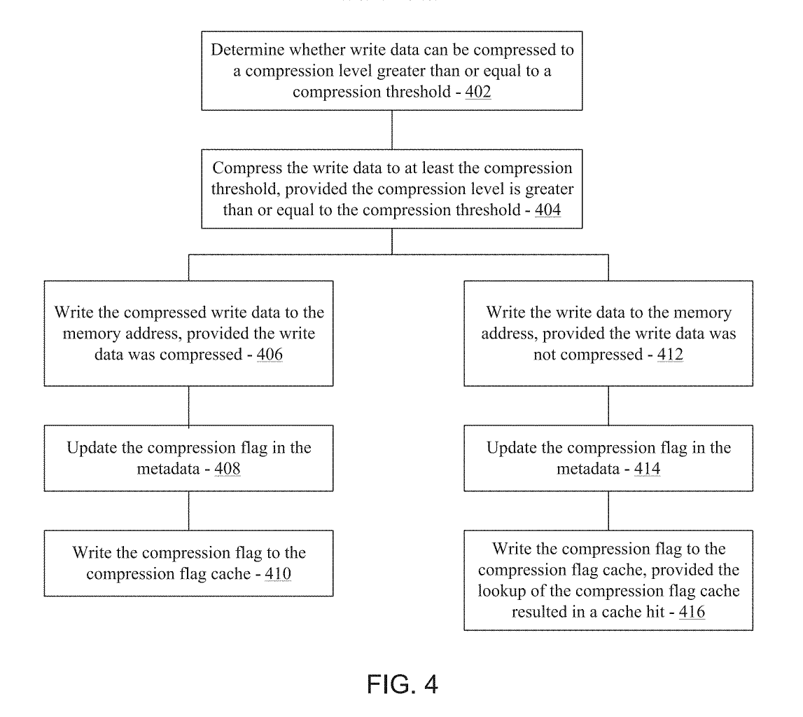

An example of the data request is a write request, as is shown in FIG. 4. The compression controller circuitry can be configured to perform the process of FIG. 4. The process of FIG. 4 can include: 402 determining whether write data associated with the write request can be compressed to a compression level greater than or equal to a compression threshold, and 404 compressing the write data, using a compression engine, to at least the compression threshold, provided the compression level is greater than or equal to the compression threshold. Provided the write data was compressed, the circuitry is further configured to 406 write the compressed write data to the memory address, 408 update the compression flag in the meta data, and 410 write the compression flag to the compression flag cache. Provided the write data was not compressed, the circuitry is further configured to 412 write the write data to the memory address, 414 update the compression flag in the metadata, and 416 write the compression flag to the compression flag cache, provided the lookup of the compression flag cache had resulted in a cache hit.

A variety of techniques can be used to determine whether the write data associated with the write request can be compressed to a compression level greater than or equal to a compression threshold, and any useful technique for doing so is considered to be within the present scope. For example, the write data can be compressed to compressed write data, and the level of compression can be the difference in size between the compressed write data and the write data (uncompressed). By comparing the compression level to the compression threshold, it can thus be readily determined whether the write data can be compressed to a compression level greater than or equal to the compression threshold. A variety of techniques can be utilized to accomplish such a comparison, such as, for example, a comparator or other logic device.

The compression level can be set to any useful value, ratio, or the like. It can be beneficial for the compression level to be set such that compressed write data can be manipulated with fewer command instructions compared to the uncompressed write data. In such cases, the compression level is related to the various data granularities of the related systems and subsystems. In the example described above and shown in FIGS. 2A-C, for example, a memory line associated with a data request is 256 bytes, while the access granularity of the memory is 128 bytes. In order to read or write the full memory line, a separate command is needed for each 128-byte memory segment. If the memory line can be compressed to a compression threshold of at least 50% (i.e. the size is reduced by 50%) of the size of the uncompressed memory line, then the 256 bytes can be written to one of the 128-byte memory segment halves of the memory line, and only one command would then be required to read or write all of the now-compressed memory line data. In a similar example where the memory line is 256 bytes and the access granularity of the memory is 64 bytes, 4 commands would be needed to transfer the entire 256-byte memory line of data. At a compression level of 25% (i.e. the size is reduced by 25%), however, 3 commands would be needed to transfer the entire memory line of data. At a compression level of 50% (i.e. the size is reduced by 50%), 2 commands would be needed to transfer the entire memory line of data, and at a compression level of 75% (i.e. the size is reduced by 75%), only 1 command would be needed to transfer the entire memory line of data. Furthermore, the compression level is not limited to increments associated with the access granularities, and can include compression level values that are intermediate to such increments.

Once it is determined whether the write data can be compressed to a compression level greater than or equal to a compression threshold, the data can be written to the memory address. If the compression level is greater than or equal to the compression threshold, the compressed write data is written to the memory address. If the compression level is less than the compression threshold, then the write data (uncompressed) is written to the memory address. Furthermore, if the write data is compressed, the circuitry updates the associated compression flag in the metadata associated with compressed write data, and the compression flag is written to the compression flag cache. On the other hand, if the write data is not compressed (other than to test the compression level), the circuitry updates the associated compression flag in the metadata associated with the uncompressed write data, and, if the lookup of the compression flag had resulted in a cache hit, the compression flag is written to the compression flag cache. In some examples, cache usage can be minimized by not writing to the cache those compression flags associated with uncompressed write data having a cache miss.

In another example, a memory line can include a compression flag for each memory segment of the memory line, similar to the example shown in FIGS. 2A-C. Thus, for a memory line with two memory segments, two compression flags can be utilized, a first compression flag for a first segment and a second compression flag for a second segment. In updating the compression flag and writing the compressed write data to the memory address, the circuitry can be configured to select the memory segment to which the compressed write data will be written, to update the associated compression flag, and to write the compressed data to the selected memory segment. In another example, the memory line can have a plurality of memory segments, each associated with one of a plurality of compression flags. In updating the compression flag and writing the compressed write data to the memory address, the circuitry can be configured to select the memory segment to which the compressed data will be written, to write the compressed data to that memory segment, to update the compression flag associated with that memory segment, and to write the plurality of compression flags to the compression flag cache.

Various techniques can be utilized to select which memory segment to write to. In one example, the compressed data can always be written to the same memory segment. Continually writing to the same memory segment, however, can cause greater wear in the memory hardware associated with that memory segment, thus potentially reducing the life of the device. It can therefore, be beneficial to level the wear effects across all, or at least a portion, of the memory segments of the memory line. As such, in one example, the memory segment having the lowest write count is selected as the memory segment to be written to, which can achieve fine-grained wear-leveling. In another example, a memory segment is selected that has a lower write count than at least one other memory segment of the memory line. In yet another example, any memory segment can be selected other than the last memory segment that was written to. In a further example, the selection of the memory segment can be random or pseudo-random. In cases where a memory line has only two memory segments, writing compressed data can be alternated between the two segments.

In some cases, the data request can be for a partial write of the memory line. In one example, the circuitry can be configured to read existing data of the memory line associated with the write data of the partial write request. In the case of two memory sections per memory line, both memory sections are read if the existing data is not compressed. However, due to the fact that all of the memory line data is present in a single memory section when compressed, only that single memory section needs to be read if the data is compressed. In the case where the memory line includes more than two memory segments and the data is compressed, data is read from all memory lines containing compressed and valid data. Following reading, if compressed, the existing data is decompressed, and the write data of the partial write request is merged with the existing data. Once the data is merged, the writing techniques described can be repeated to potentially compress the merged data, to write the merged data, and to update and write the compression flag(s) to the compression flag cache if appropriate.

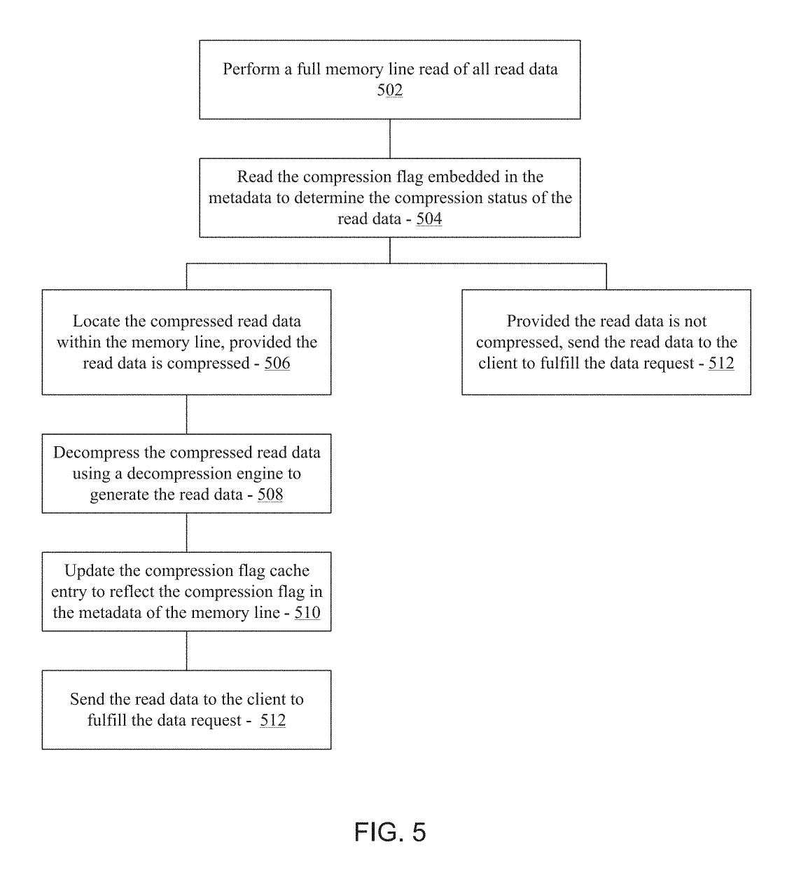

In an example where the data request is a read request and the cache lookup resulted in a miss (see FIG. 5), the compression controller circuitry is further configured to 502 perform a full memory line read of all read data, 504 read the compression flag embedded in the metadata to determine the compression status of the read data, and 506 locate the compressed read data within the memory line, provided the read data is compressed. If the data was compressed, the circuitry is further configured to 508 decompress the compressed read data using a decompression engine to generate the read data, 510 update the compression flag cache entry to reflect the compression flag in the metadata of the memory line, and 512 send the read data to the client to fulfill the data request. If the data was not compressed, the circuitry is further configured to 514 send the read data to the client to fulfill the data request.

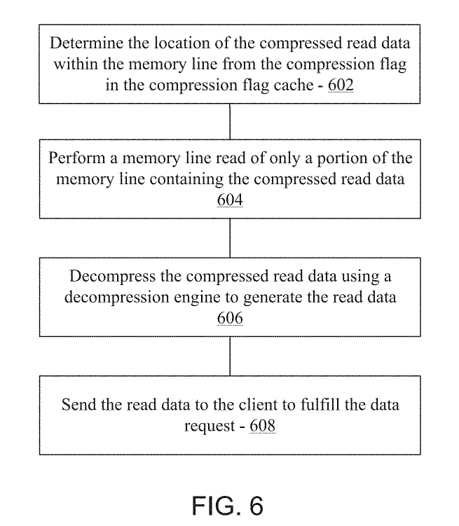

In an example where the data request is a read data request and the local compression flag cache lookup produced a cache hit (see FIG. 6), the circuitry is further configured to 602 determine the location of the compressed read data within the memory line from the compression flag in the compression flag cache, 604 perform a memory line read of only a portion of the memory line containing the compressed read data, 606 decompress the compressed read data using a decompression engine to generate the read data, and 608 send the read data to the client to fulfill the data request.

During a read access request to the memory, a look up to the local compression flag cache or storage is performed. If the compression flag entry is not valid, or in other words, is a miss, the controller will issue a full line read. Thus, instead of issuing a full read only if the memory line is uncompressed, a compression flag cache miss will trigger a full memory line read regardless of the compression state memory line. The actual compression state of the memory line is then extracted from the metadata and placed into local storage. Due to the currently disclosed implementations of metadata-resident compression flags, and the use of write-count information, a memory line with an unknown compression status can be treated as uncompressed for read purposes, the entire memory line can be read, and compression status can readily be determined from the compression flag and write-count information. Since the compression flag storage required to store all the compression flags for the whole memory capacity can be prohibitive, it can be useful to use a much smaller on-chip compression flag cache that stores the compression flags for just a small fraction of the memory lines of the memory device. Write requests are not impacted, because the compression state is known before the write request to the memory is issued.

In referring back to the example shown in FIGS. 2A-C, when the compression flag cache lookup results in a miss, a full read is performed, and the combined values of CF0 and CF1 flags indicates the compression status (compressed vs. uncompressed, and the compressed line position). One example is shown in Table 1. When both CF0 and CF1 are set to compressed, a determination is made as to which compressed memory segment (or which half of the memory line, in this case) is valid. This can be determined by comparing the write count fields for each memory segment. Since the write count field is monotonically increasing, a greater write count indicates a memory segment including a more recent write.

TABLE 1

| | | WriteCount0 > | Compression | Compression Line |
|---|---|---|---|---|
| CF0 | CF1 | WriteCount1 | Success | Position |
| 0 | 0 | Ignored | No | N/A |
| 1 | 0 | Ignored | Yes | Low Half |
| 0 | 1 | Ignored | Yes | High Half |
| 1 | 1 | Yes | Yes | Low Half |
| 1 | 1 | No | Yes | High Half |

As described above, writing to both sides (low-half, high-half) achieves a fine-grained wear-leveling that can greatly extend the life of the memory. In this example where the memory line has two memory segments, compressed writes can alternate between the memory segments to level the fine-grained wear. If the last compressed write was to the low half, for example, the next compressed write can be to the high half. Because the low half compression flag is left untouched in a subsequent compressed write (i.e., only the currently-written to memory segment's compression flag is updated), the lower half will appear to be a valid memory segment, and the metadata for the memory line will be in an ambiguous “1, 1” compression state. Upon a subsequent read, if the compression flag cache does not include the updated compression state for this memory line, the entire line is read, and the true compression state is obtained by comparing the write counts of each memory segment to one another (i.e., the higher write count contains the most recent data write). Upon receiving uncompressible data for a write request, the full memory line is written, and the compression flags for the memory line are updated to “0, 0.”

In one example relating to the caching of compression flags, memory can be organized in terms of pages, where a page is defined as a contiguous number of memory lines aligned to a multiple of pages' size addresses. Each memory line can be stored in an uncompressed manner, or if it can be compressed and stored in one or more memory segments of the memory line, as described above. The cache includes 2N page entries, one for each memory page. Each page entry includes a tag and a subentry for each memory line, where there are M memory lines per page. In each page entry, there is a 1-bit compression flag for each memory segment of each memory line. In an example where the memory line has two memory segments (e.g. a 256-byte memory line divided into two 128-byte memory segments), there are two compression flag bits for each memory line, for a total of 2M bits per page entry. These two memory line bits encode the states “uncompressed/unknown,” “compressed-hi,” and “compressed-lo.” As one example, for a 4 KB page and a 256B memory line, there are 16 memory lines per page, (i.e. M=16), and thus each page entry in the cache will have 2M bits.

In one non-limiting example, byte addresses can be mapped to the compression flag cache as follows: the low-order 8 bits can be ignored, based on a 256-byte memory line size, the next M bits can index the bits within the cache entry, and the next N bits can address the cache entry. To determine the compression state of a memory line, the compression flag cache is read, and if the entry does not match the high order address bits, then the result is unknown/uncompressed. Otherwise, bit state of the compression flag is returned. A compression flag cache write operation is similar, with the exception that, if the entry does not match, the entry is updated with the current high-order address bits, and all of the states in the entry are initialized to unknown. Then the update/write happens in the expected manner. In data writes, a read-modify-write is performed, as the size of the data granularity is less than the size of a memory line. So for both data reads and data writes, the cache is read, and then the data is read. The cache update, however, depends on whether the data request is a data-read or a data-write.

For a data-read, the compression flag cache is updated if the data of the memory line was compressed and there was not a cache hit when the compression flag cache was read. If there was a cache hit, then the compression flag cache entry is not updated. Similarly, if the data of the memory line is not compressed, there is no need to update the entry.

For a data-write, the compression flag cache is updated if the line is compressed or there was a cache hit when the compression flag cache was read. By avoiding writing uncompressed states to the compression flag cache, unnecessarily evicting previous compression flag cache entries is minimized or avoided.

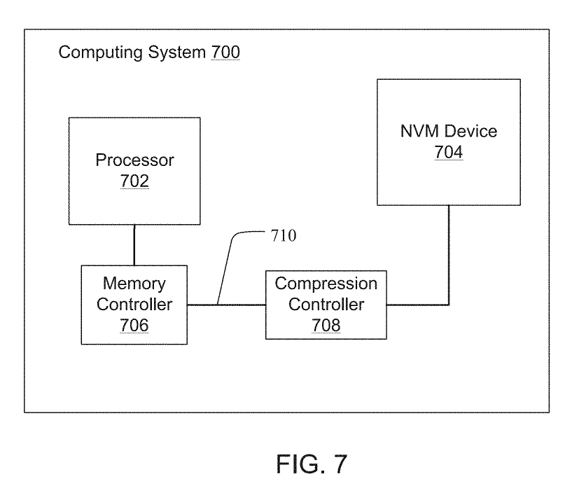

In one example, as is shown in FIG. 7, a computation system 700 is provided that can include at least one processor 702, a NVM device 704, a memory controller 706 coupled to the processor 702, and a compression controller 708 coupled to the NVM device 704 and to the memory controller 706. The compression controller 708 can be configured and described as in, for example, FIG. 1. In one example, the NVM device 704 can include an array of PCM cells. In another example, the array of PCM cells can be configured as a three-dimensional cross-point array.

The processor 702 can be a single or multiple processors, and the NVM device or subsystem 704 can be a single or multiple NVMs. One or more communication interfaces 710 can be used as pathways to facilitate communication between any of a single processor, multiple processors, a single memory, multiple memories, the various interfaces, and the like, in any useful combination.

Regarding the system as a whole, while any type or configuration of device or computing system is contemplated to be within the present scope, non-limiting examples can include laptop computers, handheld and tablet devices, CPU systems, SoC systems, server systems, networking systems, storage systems, high capacity memory systems, or any other computational system. Such systems can additionally include, in general, I/O interfaces for controlling the I/O functions of the system, as well as for I/O connectivity to devices outside of the system. A network interface can also be included for network connectivity, either as a separate interface or as part of the I/O interface. The network interface can control network communications both within the system and outside of the system. The network interface can include a wired interface, a wireless interface, a Bluetooth interface, optical interface, and the like, including appropriate combinations thereof. Furthermore, the system can additionally include various user interfaces, display devices, as well as various other components that would be beneficial for such a system. The system can also include a power supply to deliver power to the processor and other components and subsystems of the system.

The disclosed embodiments can be implemented, in some cases, in hardware, firmware, software, or any combination thereof. The disclosed embodiments can also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device). As one example, a non-transitory machine readable medium can store code that when executed configures a compression controller to perform the various operations as outlined herein.

### Examples

The following examples pertain to specific embodiments and point out specific features, elements, or steps that can be used or otherwise combined in achieving such embodiments.

In one example there is provided a device comprising:
a compression controller having circuitry configured to:
   receive a data request related to a memory address of a non-volatile memory (NVM);
   perform a lookup of a compression flag cache for a cache hit associated with the memory address;
   in response to the lookup of the compression flag cache results in a cache miss, read a compression flag embedded in metadata of a memory line associated with the data request to determine compression status of existing data; and
   perform the data request on the NVM.

In one example of a device, the data request comprises a write request, and the circuitry is further configured to:

determine whether write data associated with the write request can be compressed to a compression level greater than or equal to a compression threshold;

compress the write data, using a compression engine, to at least the compression threshold, provided the compression level is greater than or equal to the compression threshold;

write the write data to the memory address;

update a write count for the memory line; and

update the compression flag in the metadata associated with the write data.

In one example of a device, in order to determine whether the write data can be compressed, the circuitry is further configured to:

compress, using the compression engine, the write data to compressed write data, the compression level to represent a difference in size between the compressed write data and the write data; and

compare, using a comparator, the compression level against the compression threshold.

In one example of a device, in order to write the write data to the memory address, the circuitry is further configured to:

write the compressed write data to the memory address, provided the write data was compressed; or

write the write data to the memory address, provided the write data was not compressed.

In one example of a device, provided the write data was compressed, the circuitry is further configured to:

update the compression flag in the metadata; and

write the compression flag to the compression flag cache.

In one example of a device, provided the write data was not compressed, the circuitry is further configured to:

update the compression flag in the metadata; and

write the compression flag to the compression flag cache, provided the lookup of the compression flag cache resulted in a cache hit.

In one example of a device, the compression flag comprises a plurality of compression flags, each associated with one of a plurality of memory segments of the memory line, and, wherein to update the compression flag and to write the compressed data, the circuitry is further configured to:

select the memory segment to which the compressed data will be written;

write the compressed data to the selected memory segment;

update the compression flag associated with the memory segment; and

write the plurality of compression flags to the compression flag cache.

In one example of a device, to update the compression flag and to write the compressed data, the circuitry is further configured to:

determine a write count for each of the plurality of memory segments; and

write the compressed data to a memory segment that has a lower write count than at least one other memory segment of the plurality of memory segments.

In one example of a device, the data request is for a partial write, and the circuitry is further configured to:

read existing data of the memory line associated with the write data of the partial write request;

if existing data is compressed, decompress the existing data of the memory line; and

merge the write data of the partial write request with the existing data.

In one example of a device, in order to write compressed write data, the circuitry is further configured to alternate write of compressed data between at least two memory segments of the memory line.

In one example of a device, the write data is compressed to a compression level that allows a reduction in a number of memory commands to store and retrieve compressed write data compared to uncompressed write data.

In one example of a device, the data request is a read data request, the local compression flag cache lookup produced a cache miss, and the circuitry is further configured to:

perform a full memory line read of all read data;

locate the compressed read data within the memory line, provided the read data is compressed;

decompress the compressed read data using a decompression engine to generate the read data, provided the read data is compressed;

update the compression flag cache entry to reflect the compression flag in the metadata of the memory line, provided the read data is compressed; and

send the read data to a client to fulfill the data request.

In one example of a device, the data request is a read data request, the local compression flag cache lookup produced a cache hit, and the circuitry is further configured to:

determine the location of the compressed read data within the memory line from the compression flag in the compression flag cache;

perform a memory line read of the compressed read data-portion of the memory line;

decompress the compressed read data using a decompression engine to generate the read data; and

send the read data to a client to fulfill the data request.

In one example of a device, the circuitry is further configured to:

set, using the compression controller, all local compression flag cache entries to invalid upon powering up.

In one example of a device, the compression flag cache comprises a local compression flag cache.

In one example, there is provided, a memory device, comprising:

a non-volatile memory (NVM);

a compression engine;

a decompression engine;

a compression flag cache; and

circuitry configured to:
receive a data request related to a memory address in the NVM;
perform a lookup of a local compression flag cache for a cache hit associated with the memory address;
in response to the lookup of the compression flag cache results in a cache miss, read a compression flag embedded in metadata of a memory line associated with the data request to determine compression status of existing data; and
perform the data request on the NVM.

In one example of a memory device, the data request comprises a write data request, and the circuitry is further configured to:

determine whether write data associated with the write request can be compressed to a compression level greater than or equal to a compression threshold;

compress the write data, using a compression engine, to at least the compression threshold, provided the compression level is greater than or equal to the compression threshold;

write the write data to the memory address;

update a write count for the memory line; and

update the compression flag in the metadata associated with the write data.

In one example of a memory device, in order to determine whether the write data can be compressed, the circuitry is further configured to:

compress, using the compression engine, the write data to compressed write data, the compression level to represent a difference in size between the compressed write data and the write data; and

compare, using a comparator, the compression level against the compression threshold.

In one example of a memory device, in order to write the write data to the memory address, the circuitry is further configured to:

write the compressed write data to the memory address, provided the write data was compressed; or

write the write data to the memory address, provided the write data was not compressed.

In one example of a memory device, the circuitry is further configured to:

update the compression flag in the metadata; and

write the compression flag to the compression flag cache.

In one example of a memory device, the circuitry is further configured to:

update the compression flag in the metadata; and

write the compression flag to the compression flag cache, provided the lookup of the compression flag cache resulted in a cache hit.

In one example of a memory device, the compression flag comprises a plurality of compression flags, each associated with one of a plurality of memory segments of the memory line, and, wherein to update the compression flag and to write the compressed data, the circuitry is further configured to:

select the memory segment to which the compressed data will be written;

write the compressed data to the selected memory segment;

update the compression flag associated with the memory segment; and

write the plurality of compression flags to the compression flag cache.

In one example of a memory device, in order to update the compression flag and to write the compressed data, the circuitry is further configured to:

determine a write count for each of the plurality of memory segments; and

write the compressed data to a memory segment that has a lower write count than at least one other memory segment of the plurality of memory segments.

In one example of a memory device, the data request is for a partial write, and the circuitry is further configured to:

read existing data of the memory line associated with the write data of the partial write request;

if existing data is compressed, decompress the existing data of the memory line; and

merge the write data of the partial write request with the existing data.

In one example of a memory device, in order to write compressed write data, the circuitry is further configured to alternate write of compressed data between at least two memory segments of the memory line.

In one example of a memory device, the write data is compressed to a compression level that allows a reduction in a number of memory commands to store and retrieve compressed write data compared to uncompressed write data.

In one example of a memory device, the data request is a read data request, the local compression flag cache lookup produced a cache miss, and the circuitry is further configured to:

perform a full memory line read of all read data;

read the compression flag embedded in the metadata to determine the compression status of the read data;

locate the compressed read data within the memory line, provided the read data is compressed;

decompress the compressed read data using a decompression engine to generate the read data, provided the read data is compressed;

update the compression flag cache entry to reflect the compression flag in the metadata of the memory line, provided the read data is compressed; and

send the read data to a client to fulfill the data request.

In one example of a memory device, the data request is a read data request, the local compression flag cache lookup produced a cache hit, and the circuitry is further configured to:

determine the location of the compressed read data within the memory line from the compression flag in the compression flag cache;

perform a memory line read of the compressed read data-portion of the memory line;

decompress the compressed read data using a decompression engine to generate the read data; and

send the read data to a client to fulfill the data request.

In one example of a memory device, the circuitry is further configured to:

set, using the compression controller, all local compression flag cache entries to invalid upon powering up.

In one example of a memory device, the compression flag cache comprises a local compression flag cache.

In one example there is provided, a computation system, comprising:

at least one processor;

a non-volatile memory (NVM) device;

a memory controller coupled to the at least one processor; and

a compression controller coupled to the NVM device and to the memory controller, the compression controller further comprising circuitry configured to:
receive a data request related to a memory address in the NVM from the memory controller;
perform a lookup of a compression flag cache for a cache hit associated with the memory address;
in response to the lookup of the compression flag cache results in a cache miss, read a compression flag embedded in metadata of a memory line associated with the data request to determine compression status of existing data; and
perform the data request on the NVM.

In one example of a computation system, the data request comprises a write request, and the circuitry is further configured to:

determine whether write data associated with the write request can be compressed to a compression level greater than or equal to a compression threshold;

compress the write data, using a compression engine, to at least the compression threshold, provided the compression level is greater than or equal to the compression threshold;

write the write data to the memory address;

update a write count for the memory line; and

update the compression flag in the metadata associated with the write data.

In one example of a computation system, in order to determine whether the write data can be compressed, the circuitry is further configured to:

compress, using the compression engine, the write data to compressed write data, the compression level to represent a difference in size between the compressed write data and the write data; and

compare, using a comparator, the compression level against the compression threshold.

In one example of a computation system, in order to write the write data to the memory address, the circuitry is further configured to:

write the compressed write data to the memory address, provided the write data was compressed; or

write the write data to the memory address, provided the write data was not compressed.

In one example of a computation system, provided the write data was compressed, the circuitry is further configured to:

update the compression flag in the metadata; and

write the compression flag to the compression flag cache.

In one example of a computation system, provided the write data was not compressed, the circuitry is further configured to:

update the compression flag in the metadata; and

write the compression flag to the compression flag cache, provided the lookup of the compression flag cache resulted in a cache hit.

In one example of a computation system, the compression flag comprises a plurality of compression flags, each associated with one of a plurality of memory segments of the memory line, and, wherein to update the compression flag and to write the compressed data, the circuitry is further configured to:

select the memory segment to which the compressed data will be written;

write the compressed data to the memory segment;

update the compression flag associated with the memory segment; and

write the plurality of compression flags to the compression flag cache.

In one example of a computation system, in order to update the compression flag and to write the compressed data, the circuitry is further configured to:

determine a write count for each of the plurality of memory segments; and

write the compressed data to a memory segment that has a lower write count than at least one other memory segment of the plurality of memory segments.

In one example of a computation system, the data request is for a partial write, and the circuitry is further configured to:

read existing data of the memory line associated with the write data of the partial write request;

if existing data is compressed, decompress the existing data of the memory line; and

merge the write data of the partial write request with the existing data.

In one example of a computation system, in order to write compressed write data, the circuitry is further configured to alternate write of compressed data between at least two memory segments of the memory line.

In one example of a computation system, the write data is compressed to a compression level that allows a reduction in a number of memory commands to store and retrieve compressed write data compared to uncompressed write data.

In one example of a computation system, the data request comprises a read data request, the local compression flag cache lookup produced a cache miss, and the circuitry is further configured to:

perform a full memory line read of all read data;

read the compression flag embedded in the metadata to determine the compression status of the read data;

locate the compressed read data within the memory line, provided the read data is compressed;

decompress the compressed read data using a decompression engine to generate the read data, provided the read data is compressed;

update the compression flag cache entry to reflect the compression flag in the metadata of the memory line, provided the read data is compressed; and

send the read data to the memory controller to fulfill the data request.

In one example of a computation system, the data request comprises a read data request, the local compression flag cache lookup produced a cache hit, and the circuitry is further configured to:

determine the location of the compressed read data within the memory line from the compression flag in the compression flag cache;

perform a memory line read of the compressed read data-portion of the memory line;

decompress the compressed read data using a decompression engine to generate the read data; and

send the read data to the memory controller to fulfill the data request.

In one example of a computation system, the circuitry is further configured to:

set, using the compression controller, all local compression flag cache entries to invalid upon powering up.

In one example of a computation system, the NVM comprises an array of phase change memory cells (PCM).

In one example of a computation system, the array of PCM cells is configured as a three-dimensional cross-point array.

In one example of a computation system, the system further comprising one or more of:

a network interface communicatively coupled to the at least one processor;

a display communicatively coupled to the at least one processor; or

a power supply communicatively coupled to the at least one processor.

In one example there is provided, at least one non-transitory machine readable medium that stores code that when executed configures a compression controller to perform a method comprising:

receiving a data request related to a memory address of a non-volatile memory (NVM);

performing a lookup of a compression flag cache for a cache hit associated with the memory address;

in response to the lookup of the compression flag cache results in a cache miss, reading a compression flag embedded in metadata of a memory line associated with the data request to determine compression status of existing data; and

performing the data request on the NVM.

In one example of a non-transitory machine readable medium, the data request comprises a write request, and the method further comprises:

determining whether write data associated with the write request can be compressed to a compression level greater than or equal to a compression threshold;

compressing the write data, using a compression engine, to at least the compression threshold, provided the compression level is greater than or equal to the compression threshold;

writing the write data to the memory address;

updating a write count for the memory line; and

updating the compression flag in the metadata associated with the write data.

In one example of a non-transitory machine readable medium, in order to determine whether the write data can be compressed, the method further comprises:

compressing, using the compression engine, the write data to compressed write data, the compression level being the difference in size between the compressed write data and the write data; and

comparing, using a comparator, the compression level against the compression threshold.

In one example of a non-transitory machine readable medium, in order to write the write data to the memory address, the method further comprises:

writing the compressed write data to the memory address, provided the write data was compressed; or

writing the write data to the memory address, provided the write data was not compressed.

In one example of a non-transitory machine readable medium, provided the write data was compressed, the method further comprises:

updating the compression flag in the metadata; and

writing the compression flag to the compression flag cache.

In one example of a non-transitory machine readable medium, provided the write data was not compressed, the method further comprises:

updating the compression flag in the metadata; and

writing the compression flag to the compression flag cache, provided the lookup of the compression flag cache resulted in a cache hit.

In one example of a non-transitory machine readable medium, the compression flag comprises a plurality of compression flags, each associated with one of a plurality of memory segments of the memory line, and, wherein to update the compression flag and to write the compressed data, the method further comprises:

selecting the memory segment to which the compressed data will be written;

writing the compressed data to the memory segment;

updating the compression flag associated with the memory segment; and

writing the plurality of compression flags to the compression flag cache.

In one example of a non-transitory machine readable medium, to update the compression flag and to write the compressed data, the method further comprises:

determining a write count for each of the plurality of memory segments; and

writing the compressed data to a memory segment that has a lower write count than at least one other memory segment of the plurality of memory segments.

In one example of a non-transitory machine readable medium, the data request is for a partial write, and method further comprises:

reading existing data of the memory line associated with the write data of the partial write request;

if existing data is compressed, decompressing the existing data of the memory line; and

merging the write data of the partial write request with the existing data.

In one example of a non-transitory machine readable medium, to write compressed write data, the method further comprises alternating write of compressed data between at least two memory segments of the memory line.

In one example of a non-transitory machine readable medium, the data request is a read data request, the local compression flag cache lookup produced a cache miss, and the method further comprises:

performing a full memory line read of all read data;

reading the compression flag embedded in the metadata to determine the compression status of the read data;

locating the compressed read data within the memory line, provided the read data is compressed;

decompressing the compressed read data using a decompression engine to generate the read data, provided the read data is compressed;

updating the compression flag cache entry to reflect the compression flag in the metadata of the memory line, provided the read data is compressed; and

sending the read data to a client to fulfill the data request.

In one example of a non-transitory machine readable medium, the data request comprises a read data request, the local compression flag cache lookup produced a cache hit, and the method further comprises:

determining the location of the compressed read data within the memory line from the compression flag in the compression flag cache;

performing a memory line read of the compressed read data-portion of the memory line;

decompressing the compressed read data using a decompression engine to generate the read data; and

sending the read data to a client to fulfill the data request.

In one example of a non-transitory machine readable medium, the method further comprises:

setting, using the compression controller, all local compression flag cache entries to invalid upon powering up.

In one example, there is provided a method of increasing effective bandwidth in a non-volatile memory (NVM) subsystem, comprising:

receiving, from a memory controller, a data request related to a memory address in a NVM;

performing, using a compression controller, a lookup of a compression flag cache for a cache hit associated with the memory address;

in response to the lookup of the compression flag cache results in a cache miss, reading a compression flag embedded in metadata of a memory line associated with the data request to determine compression status of existing data; and

performing, using the compression controller, the data request on the NVM.

In one example of a method of increasing effective bandwidth in an NVM subsystem, the data request comprises a write request, and the method further comprises:

determining, using the compression controller, whether write data associated with the write request can be compressed to a compression level greater than or equal to a compression threshold;

compressing the write data, using a compression engine, to at least the compression threshold, provided the compression level is greater than or equal to the compression threshold;

writing the write data to the memory address;

updating a write count for the memory line; and

updating the compression flag in the metadata associated with the write data.

In one example of a method of increasing effective bandwidth in an NVM subsystem, in order to determine whether the write data can be compressed, the method further comprises:

compressing, using the compression engine, the write data to compressed write data, the compression level being the difference in size between the compressed write data and the write data; and

comparing, using a comparator, the compression level against the compression threshold.

In one example of a method of increasing effective bandwidth in an NVM subsystem, in order to write the write data to the memory address, the method further comprises:

writing the compressed write data to the memory address, provided the write data was compressed; or

writing the write data to the memory address, provided the write data was not compressed.

In one example of a method of increasing effective bandwidth in an NVM subsystem, provided the write data was compressed, the method further comprises:

updating the compression flag in the metadata; and

writing the compression flag to the compression flag cache.

In one example of a method of increasing effective bandwidth in an NVM subsystem, provided the write data was not compressed, the method further comprises:

updating the compression flag in the metadata; and

writing the compression flag to the compression flag cache, provided the lookup of the compression flag cache resulted in a cache hit.

In one example of a method of increasing effective bandwidth in an NVM subsystem, the compression flag comprises a plurality of compression flags, each associated with one of a plurality of memory segments of the memory line, and, wherein to update the compression flag and to write the compressed data, the method further comprises:

selecting the memory segment to which the compressed data will be written;

writing the compressed data to the memory segment;

updating the compression flag associated with the memory segment; and

writing the plurality of compression flags to the compression flag cache.

In one example of a method of increasing effective bandwidth in an NVM subsystem, to update the compression flag and to write the compressed data, the method further comprises:

determining a write count for each of the plurality of memory segments; and

writing the compressed data to a memory segment that has a lower write count than at least one other memory segment of the plurality of memory segments.

In one example of a method of increasing effective bandwidth in an NVM subsystem, the data request is for a partial write, and method further comprises:

reading existing data of the memory line associated with the write data of the partial write request;

if existing data is compressed, decompressing the existing data of the memory line; and

merging the write data of the partial write request with the existing data.

In one example of a method of increasing effective bandwidth in an NVM subsystem, in order to write compressed write data, the method further comprises alternating write of compressed data between at least two memory segments of the memory line.

In one example of a method of increasing effective bandwidth in an NVM subsystem, the data request is a read data request, the local compression flag cache to lookup produced a cache miss, and the method further comprises:

performing a full memory line read of all read data;

reading the compression flag embedded in the metadata to determine the compression status of the read data;

locating the compressed read data within the memory line, provided the read data is compressed;

decompressing the compressed read data using a decompression engine to generate the read data, provided the read data is compressed;

updating the compression flag cache entry to reflect the compression flag in the metadata of the memory line, provided the read data is compressed; and

sending the read data to a client to fulfill the data request.

In one example of a method of increasing effective bandwidth in an NVM subsystem, the data request comprises a read data request, the local compression flag cache lookup produced a cache hit, and the method further comprises:

determining the location of the compressed read data within the memory line from the compression flag in the compression flag cache;

performing a memory line read of the compressed read data-portion of the memory line;

decompressing the compressed read data using a decompression engine to generate the read data; and

sending the read data to a client to fulfill the data request.

In one example of a method of increasing effective bandwidth in an NVM subsystem, the method further comprises:

setting, using the compression controller, all local compression flag cache entries to invalid upon powering up.

While the forgoing examples are illustrative of the principles of invention embodiments in one or more particular applications, it will be apparent to those of ordinary skill in the art that numerous modifications in form, usage and details of implementation can be made without the exercise of inventive faculty, and without departing from the principles and concepts of the disclosure.

What is claimed is:

1. A device comprising:
a compression controller having circuitry configured to:
receive a data request related to a memory address of a non-volatile memory (NVM);
perform a lookup of a compression flag cache for a cache hit associated with the memory address;
in response to the lookup of the compression flag cache results in a cache miss, read a compression flag embedded in metadata of a memory line associated with the data request to determine compression status of existing data; and
perform the data request on the NVM.

2. The device of claim 1, wherein the data request comprises a write request, and the circuitry is further configured to:
determine whether write data associated with the write request can be compressed to a compression level greater than or equal to a compression threshold;
compress the write data, using a compression engine, to at least the compression threshold, provided the compression level is greater than or equal to the compression threshold;
write the write data to the memory address;
update a write count for the memory line; and
update the compression flag in the metadata associated with the write data.

3. The device of claim 2, wherein, to determine whether the write data can be compressed, the circuitry is further configured to:
compress, using the compression engine, the write data to compressed write data, the compression level to represent a difference in size between the compressed write data and the write data; and
compare, using a comparator, the compression level against the compression threshold.

4. The device of claim 3, wherein, to write the write data to the memory address, the circuitry is further configured to:
write the compressed write data to the memory address, provided the write data was compressed; or
write the write data to the memory address, provided the write data was not compressed.

5. The device of claim 4, wherein, provided the write data was compressed, the circuitry is further configured to:
update the compression flag in the metadata; and
write the compression flag to the compression flag cache.

6. The device of claim 4, wherein, provided the write data was not compressed, the circuitry is further configured to:
update the compression flag in the metadata; and
write the compression flag to the compression flag cache, provided the lookup of the compression flag cache resulted in a cache hit.

7. The device of claim 5, wherein the compression flag comprises a plurality of compression flags, each associated with one of a plurality of memory segments of the memory line, and, wherein to update the compression flag and to write the compressed data, the circuitry is further configured to:
select the memory segment to which the compressed data will be written;
write the compressed data to the selected memory segment;
update the compression flag associated with the memory segment; and
write the plurality of compression flags to the compression flag cache.

8. The device of claim 7, wherein, to update the compression flag and to write the compressed data, the circuitry is further configured to:
determine a write count for each of the plurality of memory segments; and
write the compressed data to a memory segment that has a lower write count than at least one other memory segment of the plurality of memory segments.

9. The device of claim 2, wherein the data request is for a partial write, and the circuitry is further configured to:
read existing data of the memory line associated with the write data of the partial write request;
if existing data is compressed, decompress the existing data of the memory line; and
merge the write data of the partial write request with the existing data.

10. The device of claim 2, wherein, to write compressed write data, the circuitry is further configured to alternate write of compressed data between at least two memory segments of the memory line.

11. The device of claim 2, wherein the write data is compressed to a compression level that allows a reduction in a number of memory commands to store and retrieve compressed write data compared to uncompressed write data.

12. The device of claim 1, wherein the data request is a read data request, the local compression flag cache lookup produced a cache miss, and the circuitry is further configured to:
perform a full memory line read of all read data;
locate the compressed read data within the memory line, provided the read data is compressed;
decompress the compressed read data using a decompression engine to generate the read data, provided the read data is compressed;
update the compression flag cache entry to reflect the compression flag in the metadata of the memory line, provided the read data is compressed; and
send the read data to a client to fulfill the data request.

13. The device of claim 1, wherein the data request is a read data request, the local compression flag cache lookup produced a cache hit, and the circuitry is further configured to:
determine the location of the compressed read data within the memory line from the compression flag in the compression flag cache;
perform a memory line read of the compressed read data-portion of the memory line;
decompress the compressed read data using a decompression engine to generate the read data; and
send the read data to a client to fulfill the data request.

14. The device of claim 1, wherein the circuitry is further configured to:
set, using the compression controller, all local compression flag cache entries to invalid upon powering up.

15. The device of claim 1, wherein the compression flag cache comprises a local compression flag cache.

16. At least one non-transitory machine readable medium that stores code that when executed configures a compression controller to perform a method comprising:
receiving a data request related to a memory address of a non-volatile memory (NVM);
performing a lookup of a compression flag cache for a cache hit associated with the memory address;
in response to the lookup of the compression flag cache results in a cache miss, reading a compression flag embedded in metadata of a memory line associated with the data request to determine compression status of existing data; and
performing the data request on the NVM.

17. The non-transitory machine readable medium of claim 16, wherein the data request comprises a write request, and the method further comprises:
determining whether write data associated with the write request can be compressed to a compression level greater than or equal to a compression threshold;
compressing the write data, using a compression engine, to at least the compression threshold, provided the compression level is greater than or equal to the compression threshold;
writing the write data to the memory address;
updating a write count for the memory line; and
updating the compression flag in the metadata associated with the write data.

18. The non-transitory machine readable medium of claim 17, wherein, to determine whether the write data can be compressed, the method further comprises:
compressing, using the compression engine, the write data to compressed write data, the compression level being the difference in size between the compressed write data and the write data; and
comparing, using a comparator, the compression level against the compression threshold.

19. The non-transitory machine readable medium of claim 18, wherein, to write the write data to the memory address, the method further comprises:
writing the compressed write data to the memory address, provided the write data was compressed; or
writing the write data to the memory address, provided the write data was not compressed.

20. The non-transitory machine readable medium of claim 19, wherein, provided the write data was compressed, the method further comprises:
updating the compression flag in the metadata; and
writing the compression flag to the compression flag cache.

21. The non-transitory machine readable medium of claim 19, wherein, provided the write data was not compressed, the method further comprises:
updating the compression flag in the metadata; and
writing the compression flag to the compression flag cache, provided the lookup of the compression flag cache resulted in a cache hit.

22. The non-transitory machine readable medium of claim 20, wherein the compression flag comprises a plurality of compression flags, each associated with one of a plurality of memory segments of the memory line, and, wherein to update the compression flag and to write the compressed data, the method further comprises:
selecting the memory segment to which the compressed data will be written;
writing the compressed data to the memory segment;
updating the compression flag associated with the memory segment; and
writing the plurality of compression flags to the compression flag cache.

23. The non-transitory machine readable medium of claim 22, wherein, to update the compression flag and to write the compressed data, the method further comprises:
determining a write count for each of the plurality of memory segments; and
writing the compressed data to a memory segment that has a lower write count than at least one other memory segment of the plurality of memory segments.

24. The non-transitory machine readable medium of claim 18, wherein the data request is for a partial write, and method further comprises:
reading existing data of the memory line associated with the write data of the partial write request;
if existing data is compressed, decompressing the existing data of the memory line; and
merging the write data of the partial write request with the existing data.

25. The non-transitory machine readable medium of claim 18, wherein, to write compressed write data, the method further comprises alternating write of compressed data between at least two memory segments of the memory line.

26. The non-transitory machine readable medium of claim 18, wherein the data request is a read data request, the local compression flag cache lookup produced a cache miss, and the method further comprises:
performing a full memory line read of all read data;
reading the compression flag embedded in the metadata to determine the compression status of the read data;
locating the compressed read data within the memory line, provided the read data is compressed;
decompressing the compressed read data using a decompression engine to generate the read data, provided the read data is compressed;
updating the compression flag cache entry to reflect the compression flag in the metadata of the memory line, provided the read data is compressed; and
sending the read data to a client to fulfill the data request.
